(19) United States
(12) Patent Application Publication
(10) Pub. No.: US 2007/0047411 A1
(43) Pub. Date: Mar. 1, 2007

(54) Method and system for verifying media compliance

(76) Inventors: Manuel Rivera, Pflugerville, TX (US); Nafisa Muzaffar, Austin, TX (US)

Correspondence Address: HAMILTON & TERRILE, LLP, P.O. BOX 203518, AUSTIN, TX, 78720, US

(21) Appl. No.: 11/215,654

(22) Filed: Aug. 30, 2005

(51) Int. Cl. G11B 19/04

(52) U.S. Cl. 369/53.21

(57) ABSTRACT

The present invention provides a method and system that is operable to detect whether optical media has appropriate identification and authentication information. Depending on whether such information is present on the media, appropriate messages are generated for the user and the write strategy for transferring data to the media is adjusted accordingly.

### BACKGROUND OF THE INVENTION

1. Field of the Invention

The present invention relates in general to the field of optical storage media, and more particularly to a method and system for verifying the authenticity of optical media.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. Information handling systems continually improve in the ability of both hardware components and software applications to generate and manage information.

As the amount of information generated by information handling systems increases, storage of the information presents a demanding challenge. One solution for storing information in removable media is provided by optical storage media, such as CD/RW and DVD/RW, which manage information in much the same manner as magnetic floppy disks but with far greater capacity. Today, a majority of the optical media is recordable, “write-once” media. CD-RW/Combo/DVD+R/RW devices and re-writable media for these devices are also increasing in popularity.

With the growth of the recordable optical media industry, optical drive write-related issues have presented a major problem for computer manufacturers and resellers. This problem is exacerbated by illegally manufactured recordable media.

All recordable optical storage media, regardless of type, is uniquely identified by a code embedded in the media. Optical drives typically identify blank recordable CD media by a code that is imbedded in an area called the ATIP. This code includes the manufacturer identification (MID), disc type, and also provides a recommended laser power setting and recording speed. Blank DVD recordable media has similar information imbedded in an area called the ADIP and also in the “Control Data Zone.” Drive suppliers use the MID information to correlate recommended laser power settings and recording speeds to help develop a write strategy for each type of media.

Whenever an optical drive encounters media with a specific MID, it will utilize the appropriate write strategy which was developed for the particular type of media associated with that MID. While this process works well for media that has valid MID information, significant problems are created by media that does not include valid MID information. In particular, if the MID is missing, or if the MID information on the ADIP does not match that of the Control Data Zone, the drive will attempt to write data to the media using a default write strategy. This situation is often encountered with illegally manufactured optical media.

Default write strategies do not always produce optimal results and, therefore, manufacturers often provide a firmware update to facilitate optimal data transfer. Since the MID information is usually missing in illegal optical media, it is not possible for an optical drive to recognize the media and to use the optimal write strategy. Therefore, the drive is forced to utilize its default write strategy, thereby providing suboptimal performance.

In view of the foregoing, it is apparent that there is a need for a method and apparatus to detect whether optical media has appropriate identification and authentication information and is further operable to control data transfer to such media depending on the existence of such information.

### SUMMARY OF THE INVENTION

In accordance with the present invention, a method and system are provided which are operable to detect whether optical media has appropriate identification and authentication information. Depending on whether such information is present on the media, appropriate messages are generated for the user and the write strategy for transferring data to the media is adjusted accordingly.

The method and apparatus of the present invention can be implemented as part of a diagnostic process. In the present invention optical media is scanned in an attempt to detect MID information. Whenever an optical drive encounters CD recordable media with no MID information on its ATIP code, the drive generates a flag to the optical drive's write engine. In addition, a message is generated to inform the user that the media has no manufacturer information and, therefore, may be illegally produced. In the present invention, a message is also generated to warn the user that the quality of the data transfer may be compromised because the media has no MID.

Whenever an optical drive encounters DVD recordable media with no MID information on its ADIP and Control Data Zone, or whenever the MID information on the ADIP does not match the MID information on the Control Data Zone, the same process explained above will be followed. In the present invention, if it is found that the media has no MID or the MID information on the ADIP does not match that of the Control Data Zone, a message is generated instructing the user to use properly manufactured recordable media.

The present invention can be implemented with no hardware changes on most information handling systems and is not limited to a specific chipset or method of error checking. Moreover, the present invention can be easily implemented on a wide variety of optical storage devices.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram of an information handling system comprising an optical storage device operable to implement the present invention for detecting the authenticity of recordable media; and

FIG. 2 is a flow diagram of the processing steps for implementing an embodiment of the present invention.

### DETAILED DESCRIPTION

In the method and system of the present invention the optical quality parameters of optical storage media are determined using various embodiments of a scan-before-burn technique described in greater detail hereinbelow. The optical quality parameters are then used by an information handling system to control the write speed for storing information on the optical storage media. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

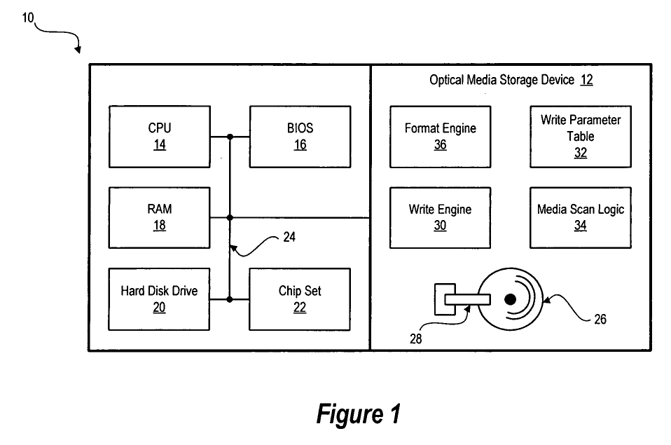

FIG. 1 is an illustration of a system block diagram of an information handling system including an optical media storage device 12. The optical media storage device is broadly comprised of a laser 28, media scan logic 34, format engine 36, write engine 30, and a write parameter table 32. The media scan logic 34 is operable to detect optical media ATIP or ADIP data parameters and to control the write speed to reduce errors, as will be described in greater detail hereinbelow. The information handling system 10 includes components that generate information for storage on optical storage media 26 by optical media storage device 12. For instance, applications running on a CPU 14 coordinate with BIOS 16, RAM 18, hard disk drive 20, and chip set 22 to transfer generated information through bus 24 to optical media storage device 12 for storage on optical media 26. A focused laser 28 moves across optical media 26 to write generated information by pulsing a focused laser beam in specific sequences with a selectively set pulse intensity and duration. The focused laser beam “burns” the information onto the optical storage media as a string of data points having varying reflectivity and/or duration readable as information by focused laser 28 at a low power.

Optical storage media 26 has a recording layer that can be made of various materials. Focused laser 28 alters the material by changing the reflective optical properties to record the information. A write engine 30 selects write parameters for focused laser 28 to heat the media material to produce desired reflectivity properties. A write parameter table 32 stores write parameters associated with different types of disks or materials so that focused laser 28 writes information with an appropriate laser beam. For instance, write parameters include write power, pulse width, timing and step power. The write engine 30 controls the various write parameters, including write speed, that are used to transfer data to the optical storage medium 26. The write engine 30 is also operable to detect write errors and to trigger a scan-before-burn routine in response thereto.

As will be understood by those of skill in the art, the speed at which data can be accurately written is limited by the quality of the optical storage media 26. In various embodiments of the present invention, media scan logic 34 is used to scan the optical storage media 26 prior to writing data to determine the characteristics of the optical storage media 26. The media scan logic 34 thereby obtains storage media performance parameters that can be used by the write engine 30 to control the write speed that is used to transfer data to the optical storage media 26 with a minimal error rate.

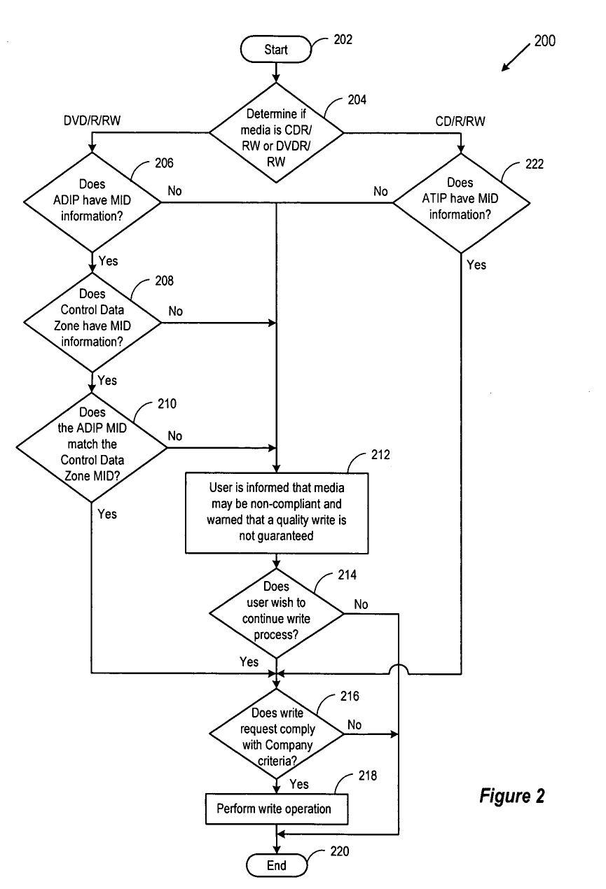

In the present invention, the optical media authentication and verification process is a routine that is implemented by the media scan logic 34 for media that is unrecognized by the optical recorder or for media that does not include MID information. The processing step for the present invention can be understood by referring to the flowchart of the processing step 200 illustrated in FIG. 2. In step 202, processing is initiated. In step 204, a test is conducted to determine if the media is CDR/RW or DVD/R/RW media. If the results of the test conducted in step 204 indicate that the media is DVD/R/RW, processing proceeds to step 206 where a test is conducted to determine whether the ADIP of the media has MID information. If the result of the test conducted in step 206 indicates that the media does not have MID information, processing proceeds to step 212 where the user is informed that the media may have been illegally manufactured and is further warned that write quality is not guaranteed. In step 214, the user is asked to determine whether he wishes to continue with the write process. If the result of the inquiry to the user in step 214 indicates that the user does not wish to proceed, processing proceeds to step 220 where the attempt to write data to the media is ended. If, however, in step 214 the user indicates that he wishes to proceed with writing data to the media, processing proceeds to step 216 where a test is conducted to determine whether the write request complies with predetermined criteria. If the results of the test conducted in step 216 indicates that the write request does not comply with predetermined criteria, the processing proceeds to step 220 where the attempt to write to the media is ended. If, however, the result of the test conducted in step 216 indicates that the write request does comply with the predetermined criteria, processing proceeds to step 218 where the write operation is performed.

Returning to step 206, if the result of the test conducted in this step indicates that the ADIP does have MID information, processing proceeds to step 208 where a test is conducted to determine whether the control data zone has MID information. If the result of the test conducted in step 208 indicates that the control data zone does not have MID information, processing proceeds to steps 212-220 as discussed hereinabove. If, however, the result of the test conducted in step 208 indicates that the control data zone does have MID information, processing proceeds to step 210 where a test is conducted to determine whether the ADIP MID matches the control data zone MID. If the result of the test conducted in step 210 indicates that the ADIP MID does not match the control data zone MID, processing proceeds to steps 212-220 as discussed hereinabove. If, however, the result of the test conducted in step 210 indicates that the ADIP MID does match the control data zone MID, processing proceeds to step 216 where a test is conducted to determine whether the write request complies with predetermined criteria. Processing proceeds through step 216-220 as discussed hereinabove.

Returning to the discussion of step 204, if the test conducted in this processing step indicates that the media is CD/R/RW, processing proceeds to step 222 where a test is conducted to determine whether ATIP has MID information. If the result of the test conducted in step 222 indicates that the ATIP does not have MID information, processing proceeds to step 212-220 as discussed hereinabove. If, however, the result of the test conducted in step 222 indicates that the ATIP does have MID information, processing proceeds directly to step 216 and the processing steps 216-220 are conducted as discussed hereinabove.

The present invention is not limited to a specific chipset or method of error checking and can be easily implemented on a wide variety of optical storage devices. Furthermore, the present invention can be used to reduce the amount of updates applied to the optical drive control firmware due to marginal media related issues. Those of skill in the art will recognize that the advantages and benefits of the method and system of the present invention is not limited to detection of the aforementioned parameters, but can be implemented by monitoring a variety of other performance parameters related to optical storage media.

Although the present invention has been described in detail, it should be understood that various changes, substitutions and alterations can be made hereto without departing from the spirit and scope of the invention as defined by the appended claims.

What is claimed is:

1. An information handling system for writing information to an optical media, the information handling system comprising:
components operable to generate information;
an optical storage device operable to write the generated information to the optical storage media with selectable write parameters;
scan control logic operable to detect parameter data associated with the origin of said optical storage media, said scan logic further being operable to generate a data signal containing said detected parameter data; and
a write engine operable to receive said data signals from said scan logic and to control the transfer of data to said optical media based on said parameter data received from said scan logic.

2. The information handling system of claim 1 wherein said optical media comprises DVD optical media.

3. The information handling system of claim 2 wherein said parameter data comprises a manufacturer identifier (MID).

4. The information handling system of claim 3 wherein said MID is stored in an ADIP portion of said DVD optical media.

5. The information handling system of claim 4 wherein said parameter data is stored in a control data zone of said DVD.

6. The information handling system of claim 3 wherein a warning message is generated by said information handling system upon failure to detect a valid MID.

7. The information handling system of claim 1 wherein said optical media comprises CD optical media.

8. The information handling system of claim 7 wherein said parameter data comprises a manufacturer identifier (MID).

9. The information handling system of claim 8 wherein said MID is stored in an ATIP portion of said CD optical media.

10. The information handling system of claim 9 wherein a warning message is generated by said information handling system upon failure to detect a valid MID.

11. A method for using an information handling system to write information to an optical storage media, the method comprising:
performing a scan-before-burn routine to detect parameter data associated with optical storage media and generating a data signal corresponding to said parameter data;
using said parameter data generated by said scan-before-burn routine to modify the write speed characteristics of a write engine; and
using said write speed characteristics to optimize writing of data on said optical storage media.

12. The method of claim 11 wherein said optical media comprises DVD optical media.

13. The method of claim 12 wherein said parameter data comprises a manufacturer identifier (MID).

14. The method of claim 13 wherein said MID is stored in an ADIP portion of said DVD optical media.

15. The method of claim 14 wherein said parameter data is stored in a control data zone of said DVD.

16. The method of claim 15 wherein a warning message is generated by said information handling system upon failure to detect a valid MID.

17. The method of claim 11 wherein said optical media comprises CD optical media.

18. The method of claim 17 wherein said parameter data comprises a manufacturer identifier (MID).

19. The method of claim 18 wherein said MID is stored in an ATIP portion of said CD optical media.

20. The method of claim 19 wherein a warning message is generated by said information handling system upon failure to detect a valid MID.
